(19) United States
(12) Patent Application Publication
(10) Pub. No.: US 2012/0013951 A1
(43) Pub. Date: Jan. 19, 2012

(54) IMAGE-READING CONTROLLING METHOD AND SCANNING APPARATUS USING SUCH METHOD

(76) Inventor: Chun-Chieh LIAO, Hsinchu City (TW)

(21) Appl. No.: 13/168,201

(22) Filed: Jun. 24, 2011

(30) Foreign Application Priority Data
Jul. 16, 2010 (TW) 099123501

(51) Int. Cl. H04N 1/32

(52) U.S. Cl. 358/442

(57) ABSTRACT

An image-reading controlling method and a scanning apparatus using such method are disclosed. The method comprises the following steps. First, a user profile is selected. Next, a computer terminal is notified that a user profile has been selected. Then, a scan command is received from the computer terminal, and an image-reading job is executed in response to the scan command.

### CROSS REFERENCE TO RELATED APPLICATIONS

This application claims the benefit of the foreign application priority of Taiwan Application No. 099123501, which was filed on Jul. 16, 2010 and is incorporated herein by reference.

### BACKGROUND OF THE INVENTION

1. Field of the Invention

The present invention relates generally to an image-reading controlling method and scanning apparatus using such method, and especially relates to a public scanning apparatus, for example, a stand-alone scanner or a MFP device, which is controlled by a computer terminal and a method which allow users to operate such public scanning apparatus at the scanner end.

2. Description of the Prior Art

Industries of computer peripherals nowadays are very mature, particularly for printers and scanners. Currently, communication networks allow business users to share hardware and software resources among them, in order to save time and money. Therefore, network scanners are being developed and manufactured to satisfy the market demand. Unlike the conventional scanner which is connected to one single computer host through a cable, the network scanner is connected to a local area network and even the internet and accessed by a plurality of computer terminals.

The scanners can be classified into two types: pull type and push type. The pull-type scanners transmit scanned images to a computer host in response to an operation command signal received from the computer host. When the user is using the pull-type scanner, the user operates the scanner through the computer host, by inputting commands to the computer host. Such, if the scanner is placed in a public place, the user has to travel to and from the scanner and the computer host, wasting time on the placement and retrieval of the physical documents.

As for the push-type scanners, they send the scan images directly to a designated file server on the network or a selected application program right after the completion of the scanning process. When the user is ready to retrieve the scan images, the user logs in to the file server manually. However, since the file server is used by a large number of users, the maintenance of the file server and the files stored thereon is critical and important.

### SUMMARY OF THE INVENTION

Accordingly, an object of the present invention is to provide an image-reading controlling method and scanning apparatus using such method, which allows users to operate the scanning apparatus at the device end and transmits scan images to personal computers or user-designated location. In addition, the present invention has the strengths of both pull-type and push-type scanners.

To achieve the afore-described object, the image-reading controlling method of the present invention comprising the following steps: selecting a user profile; notifying a computer terminal of the selection of the user profile; and receiving a scan command from the computer terminal and executing an image-reading job in response to the scan command.

These and other objects, features and advantages of the present invention will become apparent upon consideration of the following detailed description of the preferred embodiment that is illustrated in the various figures and drawings.

### BRIEF DESCRIPTION OF THE DRAWINGS

FIG. 1 is a schematic diagram of a network connecting a scanning apparatus, computer terminals and network server according to a preferred embodiment of the present invention.

FIG. 2 is a flow chart of an image-reading controlling method according to a first embodiment of the present invention.

FIG. 3 illustrates an operation interface of the scanning apparatus according to the first embodiment of the present invention.

FIG. 4 is a flow chart of the scan-image data output procedure according to the first embodiment of the present invention.

FIG. 5 is a flow chart of an image-reading controlling method according to a second embodiment of the present invention.

FIGS. 6A and 6B illustrate an operation interface of the scanning apparatus according to the second embodiment of the present invention.

FIG. 7 is a flow chart of an image-reading controlling method according to a third embodiment of the present invention.

### DETAILED DESCRIPTION

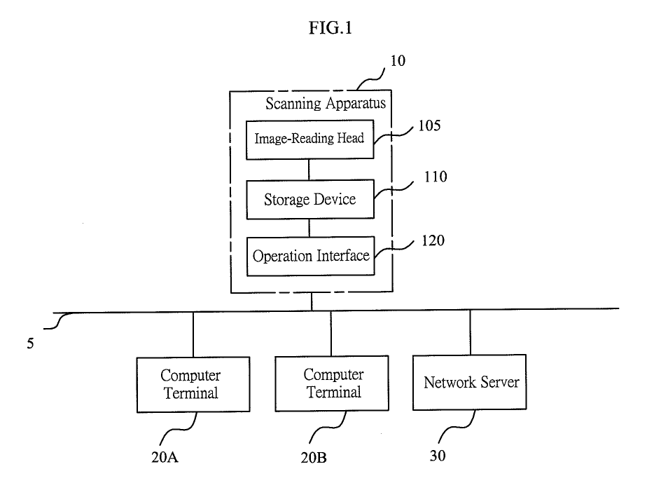

FIG. 1 is a schematic diagram of a network 5 connecting a scanning apparatus 10, computer terminals 20A, 20B and network server 30 according to a preferred embodiment of the present invention. Referring to FIG. 1, the scanning apparatus 10 may be, for example, a scanner, copier or multi-function product (MFP), or any other devices capable of reading document images. The scanning device 10 includes an image-reading head 105, a storage device 110 and an operation interface 120. The image-reading head 105 reads an image of a document and generates scan-image data. The storage device 110 stores data, for example, the scan-image data and user profiles. The operation interface 120, such as a touch panel or buttons, keypads or any graphical user interface (GUI), is provided for users to adjust device settings and input parameters and commands. The scanning apparatus 10 is connected to the computer terminals 20A, 20B and the network server 30 in the network 5, whether wired through cables or wireless through Wi-Fi, 3G and etc. Alternatively, the scanning apparatus 10 can be connected to the computer terminal 20A in a short distance through USB cable, Bluetooth, and etc.

For example, when the computer terminal 20A is registered on the scanning apparatus 10, the computer terminal 20A transmits the information, such as COMPUTER ID, or even user profiles, to the scanning apparatus 10, and stores the information on the scanning apparatus 10. The COMPUTER ID may include the ID number or name of the registered computer terminal 20A or its IP address. The user profiles which have been created by a user on the computer terminal 20A include the user preferences for the settings of the scanning apparatus 10. In the user profile, settings for the file format of the scan-image data and the output destination thereof are included. In addition, the user profile may further include COMPUTER ID, user preferences for image color & shade, paper layout, or address books. If the scanning apparatus 10 of the present invention is a public scanner, more than one computer terminals 20A, 20B will be registered on the scanning apparatus 10; and more than one COMPUTER IDs and user profiles will be stored in the scanning apparatus 10, such that users may select from these options.

### First Embodiment

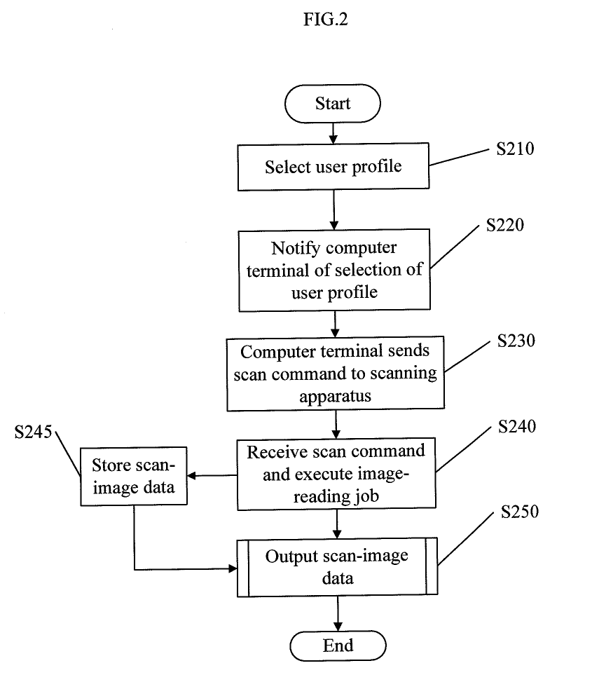

FIG. 2 is a flow chart of an image-reading controlling method according to a first embodiment of the present invention. Referring to FIGS. 1 and 2, in this embodiment, the image-reading controlling method comprises the following steps. First, in step 210, the scanning apparatus 10 selects a user profile according to the user input via the operation interface 120. Then, in step 220, the scanning apparatus 10 notifies the computer terminal 20A corresponding to the user file, of the selection of the user profile. Next, in step 230, the computer terminal 20A sends a scan command to the scanning apparatus 10 after receiving the notification. In step 240, the scanning apparatus 10 receives the scan command and executes an image-reading job responsively. The scanning apparatus 10 executes the image-reading job and generates scan-image data according to the user profile. Finally, in steps 245 and 250, the scanning apparatus 10 stores or outputs the scan-image data. The scanning apparatus 10 may store the scan-image data in its storage device 110, transmit the data to the computer terminal 20A or network server 30, or process the scan-image data and send the processed data to other destinations via email or fax, or to a printer for print out, according to the default settings of the apparatus 10 or the settings included in the user profile.

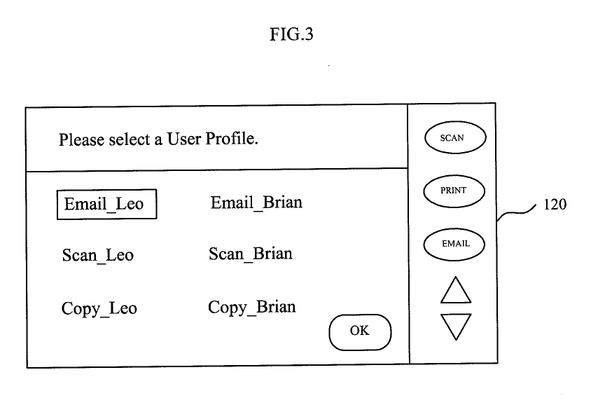

FIG. 3 illustrates an operation interface 120 of the scanning apparatus 10 according to the first embodiment of the present invention. As shown in FIG. 3, when a number of user profiles are stored in the scanning apparatus 10, the apparatus 10 displays the codenames of the user profiles, for example, Email_Leo, Email_Brian, Scan_Leo, Scan_Brian, Copy_Leo and Copy_Brian. The users can select their own user profiles to carry out personal settings of the apparatus 10.

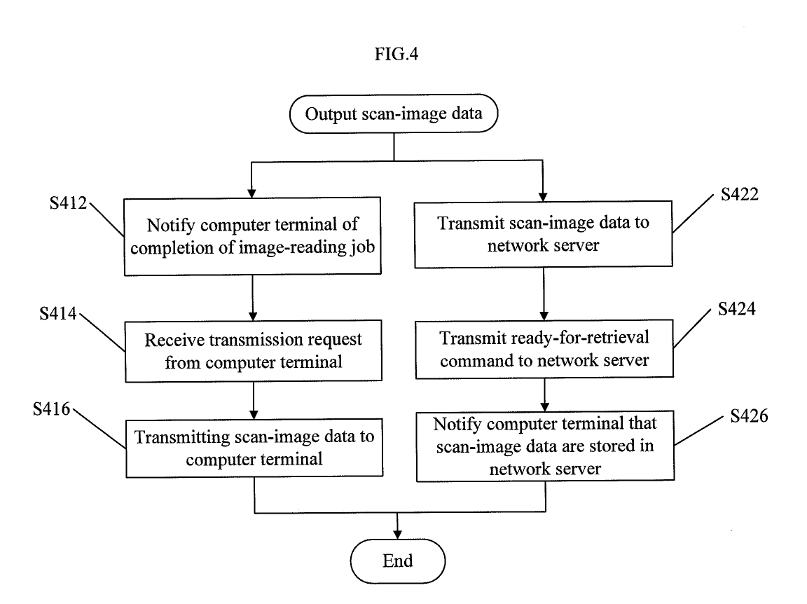

FIG. 4 is a flow chart of the scan-image data output procedure according to the first embodiment of the present invention. Referring to FIGS. 2 and 4, at the time the computer terminal 20A sends the scan command to the scanning apparatus 10, it also sends a transmission request to the apparatus 10. After the completion of the image-reading job, the scanning apparatus 10, in response to the transmission request, outputs the scan-image data to the computer terminal 20A. Alternatively, the scanning apparatus 10, as shown in step 412, notifies the computer terminal 20A that the image-reading job is completed after the completion of the image-reading job, and when the computer terminal 20A receives the notification, it sends the transmission request to the scanning apparatus 10. Next, insteps 414 and 416, when the scanning apparatus 10 receives the transmission request, it outputs the scan-image data to the computer terminal 20A. If the scanning apparatus 10 stores the scan-image data in the storage device 110 according to the selected user profile, the scanning apparatus 10 will transmit the scan-image data from the storage device 110 to the computer terminal 20A, in response to the transmission request.

Referring to steps 422 and 424, when the scanning apparatus 10 outputs the scan-image data to the network server 30, it also transmits a ready-for-retrieval command to the network server 30. The ready-for-retrieval command instructs the network server 30 to notify the computer terminal 20A that the scan-image data are stored in the network server 30. By such notification from the network server 30, the computer terminal 20A knows where to retrieve the scan-image data. Alternatively, or at the same time the ready-for retrieval command is sent to the network server 30, the scanning apparatus 10 notifies the computer terminal 20A that the scan-image data are stored in the network server 30, as shown in step 426, in case the network server 30 is not responding to signals from outside.

After receiving the scan-image data, the computer terminal 20A stores or open the files of the scan-image data, or execute programs corresponding to the setting in the user profile, for example, opening the email application and converting the scan-image data into email attachments.

### Second Embodiment

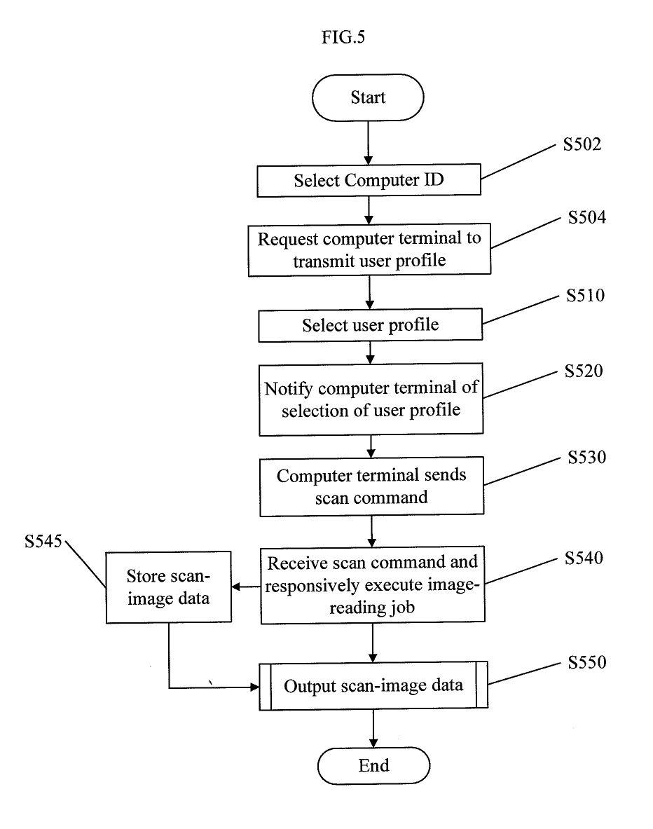

FIG. 5 is a flow chart of an image-reading controlling method according to a second embodiment of the present invention. Referring to FIGS. 1 and 5, the difference between the first embodiment and the second embodiment is that in the second embodiment the scanning apparatus 10 first selects a COMPUTER ID corresponding to the computer terminal 20A. When the computer terminal 20A is registered on the scanning apparatus 10, it sends its COMPUTER ID to the scanning apparatus 10. By receiving user input via the operation interface 120, the scanning apparatus 10, in step 502, selects the COMPUTER ID corresponding to the computer terminal 20A. Next, in step 504, the scanning apparatus 10 requests the computer terminal 20A to transmit one or more user profiles. Please note that more than one user profiles may be sent to the scanning apparatus 10 if more than one user profiles are created or stored on the computer terminal 20A. When receiving the user profiles, the scanning apparatus 10 displays the codenames or representative icons of the user profiles on the operation interface 120. The user can select from the codenames or icons shown.

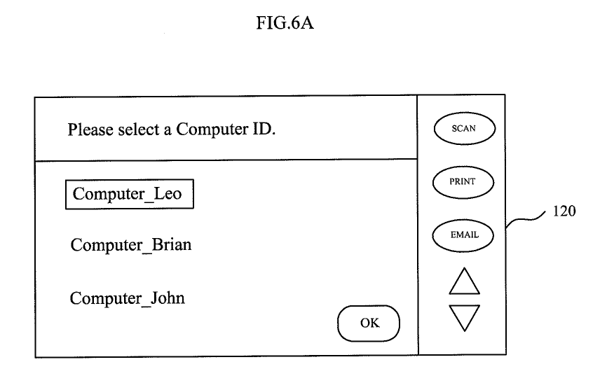

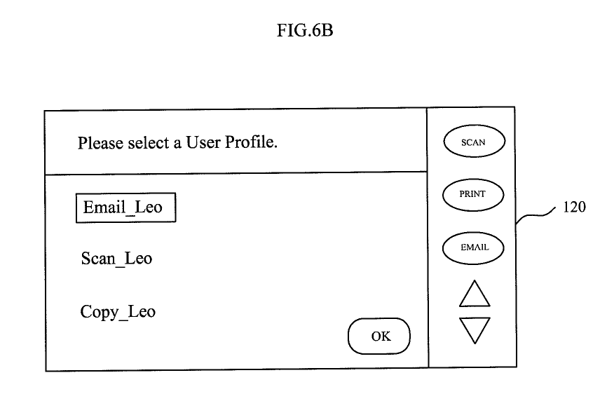

FIGS. 6A and 6B illustrate an operation interface 120 of the scanning apparatus 10 according to the second embodiment of the present invention. As shown in FIG. 6A, a number of COMPUTER IDs corresponding to each individual computer terminal 20A, 20B, . . . , i.e., Computer_Leo, Computer_Brian and Computer_John, are displayed on the operation interface 120. When the user selects one of the COMPUTER IDs, for example, Computer_Leo, the scanning apparatus 10 notifies the Computer_Leo and requests the Computer_Leo to transmit user profile(s). Then, when receiving Computer_Leo's user profiles, the scanning apparatus 10 displays the codenames of the user profiles, Email_Leo, Scan_Leo and Copy_Leo, on the screen of the operation interface 120, as shown in FIG. 6B. The user can select the job(s) it wishes to carry out and personalize the setting of the scanning apparatus 10. The advantages of this embodiment include the effective utilization of the memory storage of the scanning apparatus 10 and better accessibility for user to search for their personal user profiles. The scanning apparatus 10 only stores COMPUTER ID information corresponding to computer terminals and receives the user profiles from the computer terminals only when requested.

### Third Embodiment

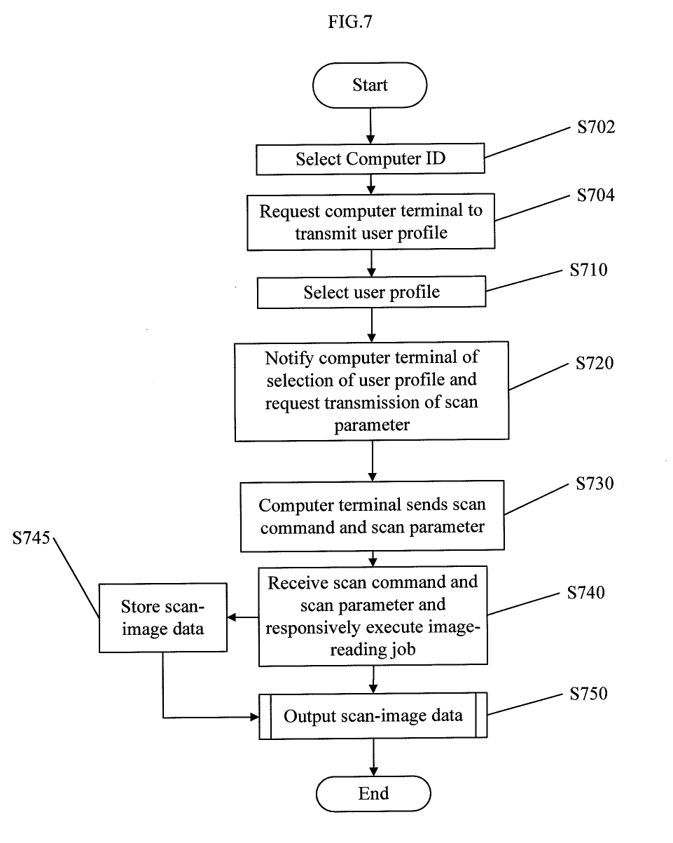

FIG. 7 is a flow chart of an image-reading controlling method according to a third embodiment of the present invention. Referring to FIGS. 1 and 7, in this third embodiment, the scanning apparatus 10 requests the computer terminal 20A to transmit a scan parameter SP after selecting the user profile, as shown in step 720. The scan parameter SP is used in the execution of the image-reading job and generation of the scan-image data. That is, the user profile only contains the information of the output destination and file format of the scan-image data, but not the detailed settings, such as image resolutions, contrast, density, gamma correction, color/B/W/gray settings, in order to reduce the size of the user profiles. Only after the user profile is selected, the scanning apparatus 10 requests the computer terminal 20A to transmit the scan parameter(s). Next, in step 730, after receiving the request, the computer terminal 20A sends the scan parameter to the scanning apparatus 10. Finally, in step 740, the scanning apparatus 10 executes the image-reading job and generates the scan-image data according to the scan parameter.

The image-reading controlling method and scanning apparatus of the present invention, as disclosed and described in the above embodiments, demonstrate considerable improvement over the prior art, for example:

1. The users can handle the entire document scan job at the scanner end without user operation from the computer terminal and without going back and forth between the computer terminal and the scanner. In this way, time for carrying out the document scan job can be immensely reduced.

2. Even though the entire operation of the scanner is done at the scanner end, the scan-image data can be sent to the computer terminal automatically after the completion of the scan job, without manual operation from user or the execution of another application program to retrieve the scan-image data.

While the present invention has been described with respect to a limited number of embodiments, it is to be understood that the present invention is not limited to the disclosed exemplary embodiments. It is intended that the appended claims cover all modifications, equivalent structures and variations as fall within the true spirit and scope of this present invention. The specification and drawings are, accordingly, to be regarded in an illustrative rather than a restrictive sense.

What is claimed is:

1. An image-reading controlling method used in a scanning apparatus connected to a computer terminal, the method comprising steps of:
selecting a user profile;
notifying the computer terminal of the selection of the user profile; and
receiving a scan command from the computer terminal and executing an image-reading job in response to the scan command.

2. The method of claim 1, wherein the step of executing the image-reading job comprises:
executing the image-reading job and generating scan-image data according to the user profile.

3. The method of claim 2, further comprising a step of:
requesting the computer terminal to transmit a scan parameter, wherein the scan parameter is used in executing the image-reading job and generating the scan-image data.

4. The method of claim 1, further comprising a step of:
transmitting the scan-image data to the computer terminal.

5. The method of claim 4, wherein the step of transmitting the scan-image data to the computer terminal comprises:
transmitting the scan-image data to the computer terminal in response to a transmission request received from the computer terminal.

6. The method of claim 4, wherein the step of transmitting the scan-image data to the computer terminal comprises:
notifying the computer terminal of completion of the image-reading job; and
receiving from the computer terminal a transmission request and responsively transmitting the scan-image data to the computer terminal.

7. The method of claim 6, wherein the step of responsively transmitting the scan-image data to the computer terminal comprising:
transmitting the scan-image data stored in a storage device of the scanning apparatus to the computer terminal.

8. The method of claim 1, wherein before the step of selecting the user profile, the method further comprises steps of:
selecting an COMPUTER ID corresponding to the computer terminal;
requesting the computer terminal to transmit the user profile; and
receiving the user profile.

9. The method of claim 1, further comprising steps of:
transmitting the scan-image data to a network server; and
transmitting a ready-for-retrieval command to the network server, wherein the ready-for-retrieval command instructs the network server to notify the computer terminal that the scan-image data are stored in the network server.

10. The method of claim 9, further comprising a step of:
notifying the computer terminal of the completion of the image-reading job.

11. The method of claim 1, further comprising a step of:
storing the scan-image data to a storage device of the scanning apparatus according to the user profile.

12. The method of claim 1, further comprising a step of:
processing the scan-image data and outputting processed data to a destination via email according to the user profile.

13. The method of claim 1, further comprising a step of:
processing the scan-image data and outputting processed data to a destination via email according to the user profile.

14. The method of claim 1, further comprising a step of:
processing the scan-image data and outputting processed data to a printer according to the user profile.
